(19) United States
(12) Patent Application Publication
(10) Pub. No.: US 2016/0101422 A1
(43) Pub. Date: Apr. 14, 2016

(54) RACK

(71) Applicant: Roche Diagnostics Operations, Inc., Indianapolis, IN (US)

(72) Inventors: Armin Bucher, Neuenkirch (CH); Thomas Guggisberg, Boswil (CH); Stephan Sattler, Starnberg (DE); Martin Halter, Oberarth (CH)

(21) Appl. No.: 14/872,471

(22) Filed: Oct. 1, 2015

(30) Foreign Application Priority Data
Oct. 10, 2014 (EP) 14188485.8

(51) Int. Cl. B01L 9/00

(52) U.S. Cl. CPC B01L 9/543; B01L 2200/025; B01L 2300/0809

(57) ABSTRACT

A rack for holding assay tips with improved stacking is provided. The rack has guiding elements arranged near opposing edges of at least two substantially orthogonal side walls of the peripheral wall of the rack configured to provide an early alignment of the rack with a similar rack, such that assay tips received in the rack nest into the assay tips received in the similar rack when the racks are stacked.

### CROSS-REFERENCE TO RELATED APPLICATIONS

This application claims priority to EP 14188485.8, filed Oct. 10, 2014, which is hereby incorporated by reference.

### BACKGROUND

The present disclosure generally relates to field of processing fluid biological samples for analytical purposes and, in particular, to a rack for holding assay tips and/or assay cups for use in analytical systems.

The processing of biological materials is of considerable significance for analytical purposes. Automated liquid handling devices are commonly used in such processes. Devices are commercially available which may include an automated pipetting head assembly movable within the device so that it may be aligned with test tubes or vials for reagent liquid handling.

In some automated liquid handling devices, a pipette head assembly uses disposable assay tips to aspirate and release samples and reagents. Such assay tips are usually provided in a rack (such as shown in FIG. 1) comprising assay tip through boreholes having seating areas for removably receiving the assay tips. Furthermore, such racks may also comprise assay cup through boreholes having seating areas for removably receiving the assay cups used as reaction vessels.

Racks are commonly supplied and/or stored in (pre-configured) stacks of racks (such as shown in FIG. 3). Each rack is pre-loaded with a defined number of assay tips 100 and, optionally, assay cups 200. To reduce the height of the stack of racks, and, hence, the space needed to store the assay tips, the racks are configured to nest when they are stacked, that is with the assay tips in each rack nesting in the assay tips in the rack below. Therefore, on one hand, the racks nest in the sense that a lower part of an upper rack accommodates an upper part of a lower rack on which the upper rack is stacked. On the other hand, the assay tips nest in the sense that a part of a pointed portion of an assay tip in the upper rack is located inside a neck portion of an assay tip in the corresponding location in the lower rack.

As noted above, it is advantageous to stack the racks with the racks and the assay tips in a nesting arrangement to conserve packaging and storage space. However, when a conventional nestable rack is stacked on another similar rack with the assay tips in a nesting arrangement, there is a risk that, during the stacking process the rack(s) are not properly aligned and thus assay tip(s) in the upper rack collide with the assay tip(s) in the rack below.

To address this problem, prior art racks 10, such as shown in FIGS. 1-3, comprise guiding element(s)—in the form of slits 50 and corresponding rails 60—arranged in the center of a side wall of the peripheral skirt 70 of the prior art racks 10. As illustrated in FIG. 2, when a prior art rack 10 is stacked over a similar rack 10′, rail(s) 60 of one rack 10 slide into corresponding slit(s) 50′ of the other rack 10′. Therefore, if the racks 10, 10′ are misaligned, the guiding element(s) force the racks 10, 10′ into alignment as they are stacked. The racks 10, 10′ are forced into alignment when a guiding length G_{LO} is reached. Therefore, the racks 10, 10′ must be configured such that in view of the size and shape of the assay tips 100—in particular the inner diameter of their neck portion—the pointed portion of the assay tips 100 held in the upper rack 10 only reach the neck portion of the assay tips held in the lower rack 10′ after the racks have been sufficiently aligned. Therefore, there must be a direct correlation between the assay tips and the racks. Thus, a compromise must be made between the height of the racks and the alignment provided by the guiding elements.

In order to reduce sample volume and to allow for pipetting out of smaller sample cups, the diameter of the assay tips needs to be reduced, but this increases the risk of assay tip collision and thus assay tip damage upon stacking of the racks. Furthermore, in certain applications, the number of assay tips per rack needs to be increased, leading to a higher rack size and/or higher assay tip density. Under these conditions, prior art racks could only be configured to prevent assay tip collisions by significantly increasing the height of the racks. However keeping the rack height as low as possible is highly desirable to conserve rack raw material.

Embodiments of the disclosed rack therefore aim to provide improved stacking capability while ensuring that assay tip collision is avoided despite possible misalignment as the racks are being stacked.

Therefore, this is a need for a rack with improved stacking capability while ensuring that assay tip collision is avoided despite possible misalignment as the racks are being stacked.

### SUMMARY

According to the present disclosure, a rack for holding assay tips is presented. The rack can comprise a surface plate. The surface plate can comprise assay tip through boreholes extending substantially in a Z direction orthogonal to the surface plate. The assay tip through boreholes can have seating areas for receiving assay tips in the rack. The rack can further comprise a peripheral skirt extending from a periphery of the surface plate substantially in the Z direction and at least four guiding elements extending substantially in the Z direction. A first pair of the four guiding elements can be respectively arranged near opposing edges of a first side wall of the peripheral skirt and a second pair of the four guiding elements can be respectively arranged near opposing edges of a second side wall of the peripheral skirt, substantially orthogonal to the first side wall. Each guiding element can comprise a slit and a corresponding rail. The guiding elements can be arranged such that the rail of the rack is guided into a corresponding slit of a similar rack thereby aligning the rack and a similar rack and such that assay tips can be received in the assay tip through boreholes of the rack nest into the assay tips received in assay tip through boreholes of the similar rack when the racks are stacked.

Accordingly, it is a feature of the embodiments of the present disclosure to provide for a rack with improved stacking capability while ensuring that assay tip collision is avoided despite possible misalignment as the racks are being stacked. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a perspective view of a prior art rack having centrally arranged guiding elements according to the prior art.

FIG. 2 illustrates a cross section along plane Z-X of the prior art rack of FIG. 1 according to the prior art.

FIG. 3 illustrates a perspective view of a stack of prior art racks according to the prior art.

FIG. 4A illustrates a perspective view of a rack according to an embodiment of the present disclosure.

FIG. 4B illustrates a top view of the rack of FIG. 4A according to an embodiment of the present disclosure.

FIG. 4C illustrates a cross section along plane Z-X of the rack of FIG. 4A according to an embodiment of the present disclosure.

FIG. 5 illustrates the horizontal misalignment of the racks upon stacking according to an embodiment of the present disclosure.

FIG. 6 illustrates a cross section along plane Z-X of the stacking of racks according to an embodiment of the present disclosure.

FIG. 7A illustrates a detail of a cross section along plane Z-X of the stacking of racks, during horizontal but before vertical alignment according to an embodiment of the present disclosure.

FIG. 7B illustrates a detail of a cross section along plane Z-X of the stacking of racks, after horizontal but before vertical alignment according to an embodiment of the present disclosure.

FIG. 7C illustrates a detail of a cross section along plane Z-X of the stacking of racks, during vertical alignment according to an embodiment of the present disclosure.

FIG. 7D illustrates a detail of a cross section along plane Z-X of the stacking of racks, after both horizontal and vertical alignment according to an embodiment of the present disclosure.

FIG. 8A illustrates a perspective view of two nested assay tips according to an embodiment of the present disclosure.

FIG. 8B illustrates a cross section of an assay tip as received in an assay tip through borehole nesting into an assay tip received in an assay tip through borehole of a similar rack, when the racks are stacked according to an embodiment of the present disclosure.

FIG. 9A illustrates a perspective view of a stack of racks according to an embodiment of the present disclosure.

FIG. 9B illustrates a cross section along plane Z-X of the stack of racks of FIG. 9A according to an embodiment of the present disclosure.

FIG. 10A illustrates a perspective view of a a rack, configured to receive both assay tips and assay cups according to an embodiment of the present disclosure.

FIG. 10B illustrates a top view of the rack of FIG. 10A according to an embodiment of the present disclosure.

FIG. 10C illustrates a top-perspective view of the rack of FIG. 10A according to an embodiment of the present disclosure.

FIG. 11 illustrates a perspective view of a stack of racks of FIGS. 10A and 10B according to an embodiment of the present disclosure.

FIG. 12 illustrates a perspective view of a rack according to a particular design, with optional elements shown in broken lines according to an embodiment of the present disclosure.

FIG. 13 illustrates a top view of a rack, with optional elements shown in broken lines according to an embodiment of the present disclosure.

FIG. 14 illustrates a perspective view of a stack of racks, with optional elements shown in broken lines according to an embodiment of the present disclosure.

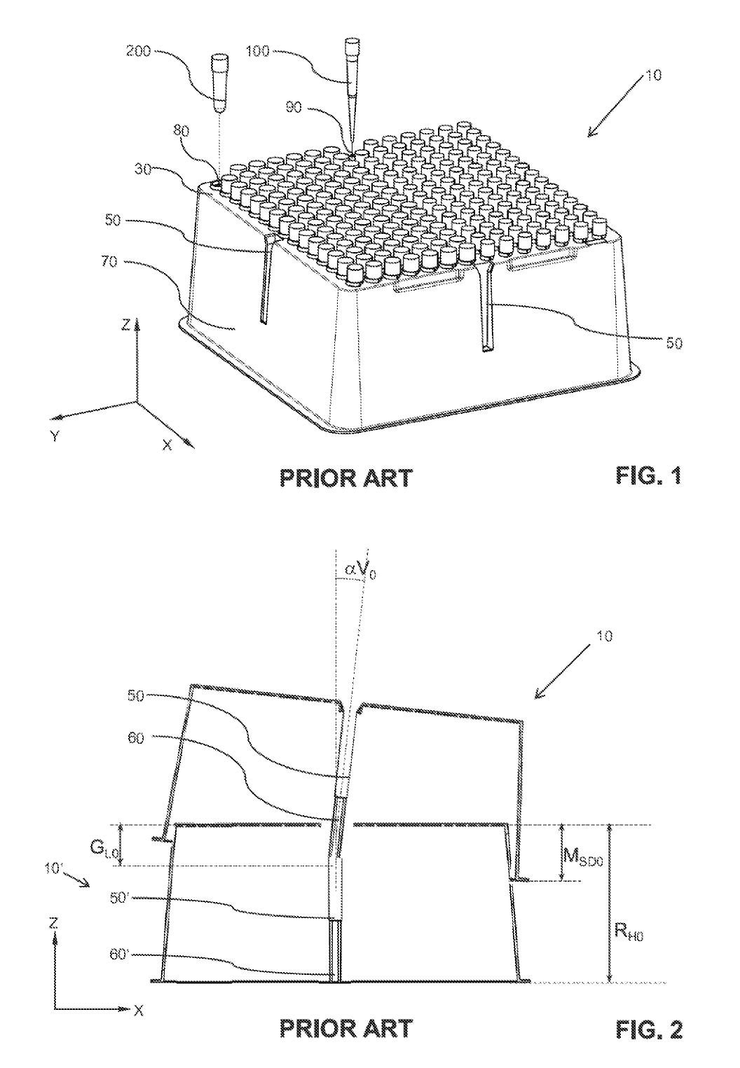

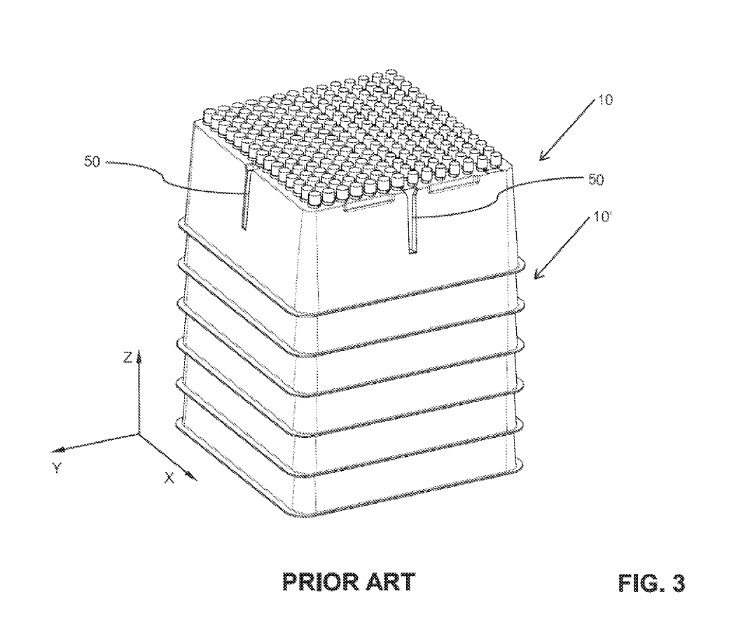

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

The disclosed rack is based on the recognition that, before the centrally arranged guiding elements of prior art racks start to engage and thus align the prior art racks, a too high of a misaligned stacking depth M_{SD0} can already be reached, especially in areas around the edges/and corners of the prior art racks 10, such as is illustrated in FIG. 2.

In order to reduce the misaligned stacking depth by ensuring an early alignment, the guiding elements of the disclosed racks can be arranged near the edges of the side walls of the the peripheral skirt. Additionally, in order to provide an alignment of the racks for both positive and negative vertical misalignment angles, a pair of guiding elements can be arranged along opposing edges of the side wall(s). Furthermore, in order to provide an alignment of vertical misalignment in both the Z-Y and Z-X planes of the three-dimensional Cartesian coordinate system, four guiding elements of the disclosed racks can be arranged near opposing edges of two substantially orthogonal side walls of the peripheral skirt.

The drawbacks of prior art racks are addressed by embodiments of the disclosed rack. In one embodiment, the disclosed rack can include: a surface plate, the surface plate comprising assay tip through boreholes extending substantially in a Z direction orthogonal to the surface plate, the assay tip through boreholes having seating areas for receiving assay tips in the rack; a peripheral skirt extending from a periphery of the surface plate substantially in the Z direction; and at least four guiding elements extending substantially in the Z direction. A first pair of the four guiding elements can respectively be arranged near opposing edges of a first side wall of the peripheral skirt and a second pair of the four guiding elements can respectively be arranged near opposing edges of a second side wall of the peripheral skirt, substantially orthogonal to the first side wall. Each guiding element can comprise a slit and a corresponding rail. The guiding elements can be arranged such that the rail of the rack can be guided into a corresponding slit of a similar rack thereby aligning the rack and a similar rack and such that assay tips can be received in the assay tip through boreholes of the rack nest into the assay tips received in assay tip through boreholes of the similar rack when the racks are stacked.

Embodiments of the disclosed rack can be particularly advantageous as an early guidance during a stacking process can be provided in two dimensions, thereby avoiding increase of or even allowing a reduction of the stacking height despite increased assay tip density and/or increased rack size and/or decreased assay tip dimensions, such as in particular, a decrease in assay tip diameter.

In addition, further embodiments of the disclosed rack can comprise guiding elements configured to provide both vertical and horizontal alignment of the racks.

In order to further improve alignment, according to further embodiments of the disclosed rack; an increased guiding length of the guiding elements may be provided such that the rack height can be defined as the sum of the assay tip height and the guiding length. These further embodiments of the disclosed rack can be particularly advantageous as the guiding length may be increased—thereby improving alignment—without affecting the stacking height of the racks. Thus, in these embodiments, while the rack height of individual rack(s) is increased, the height of a stack of racks can only be increased by the height increase of one rack because the stacking height can only be affected by the safe nesting depth of assay tips and not the guiding length.

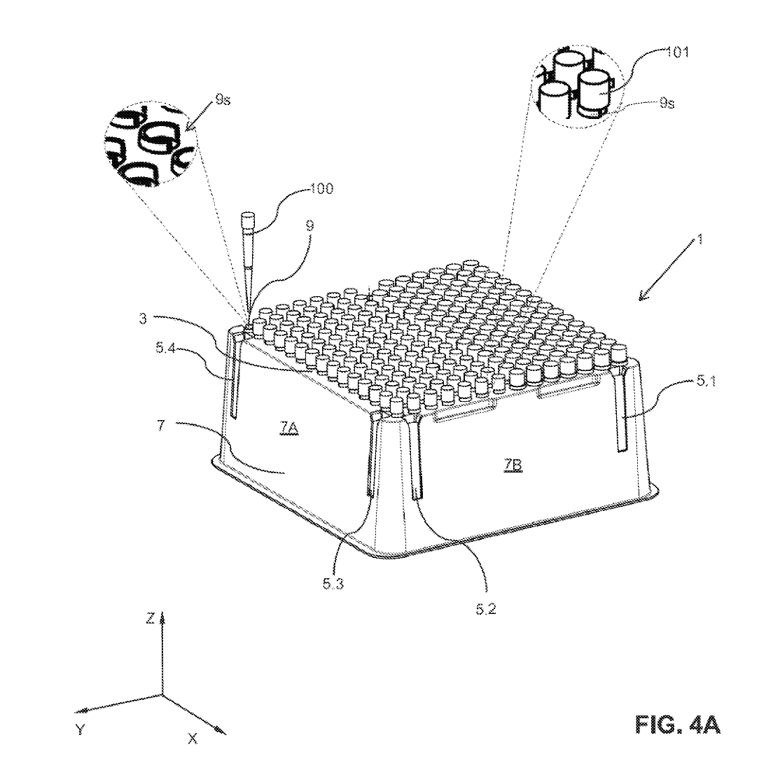

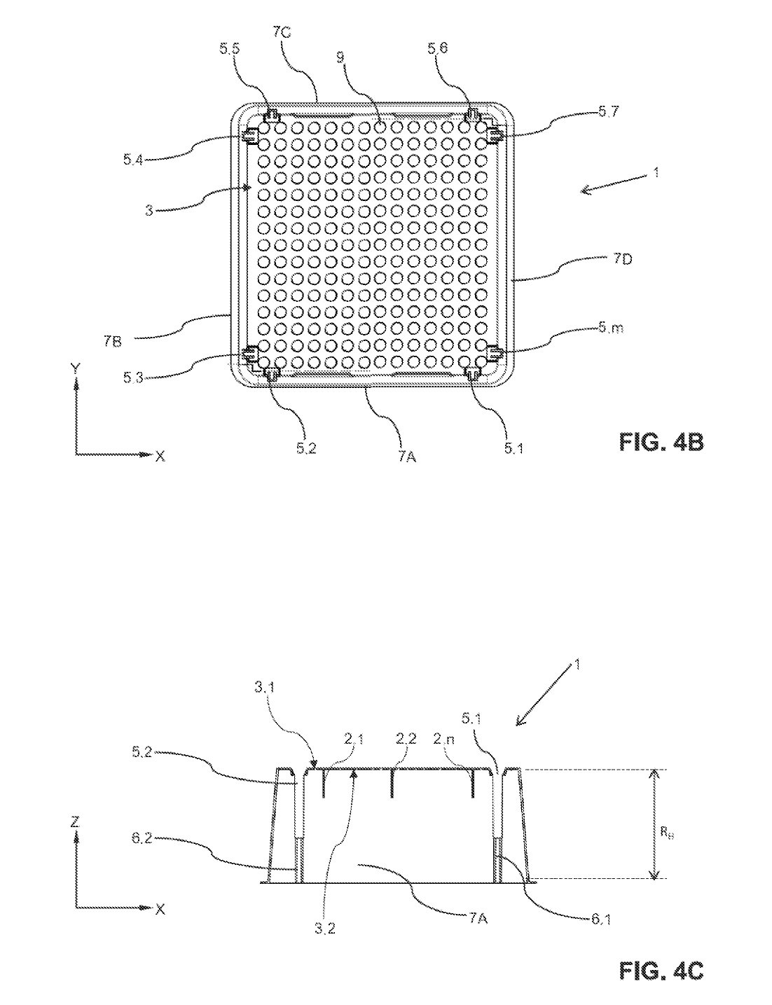

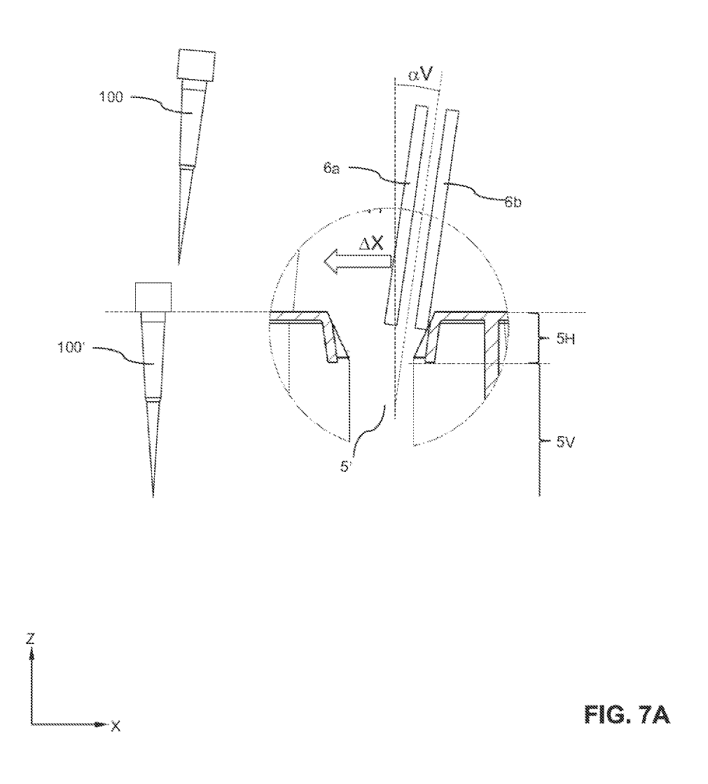

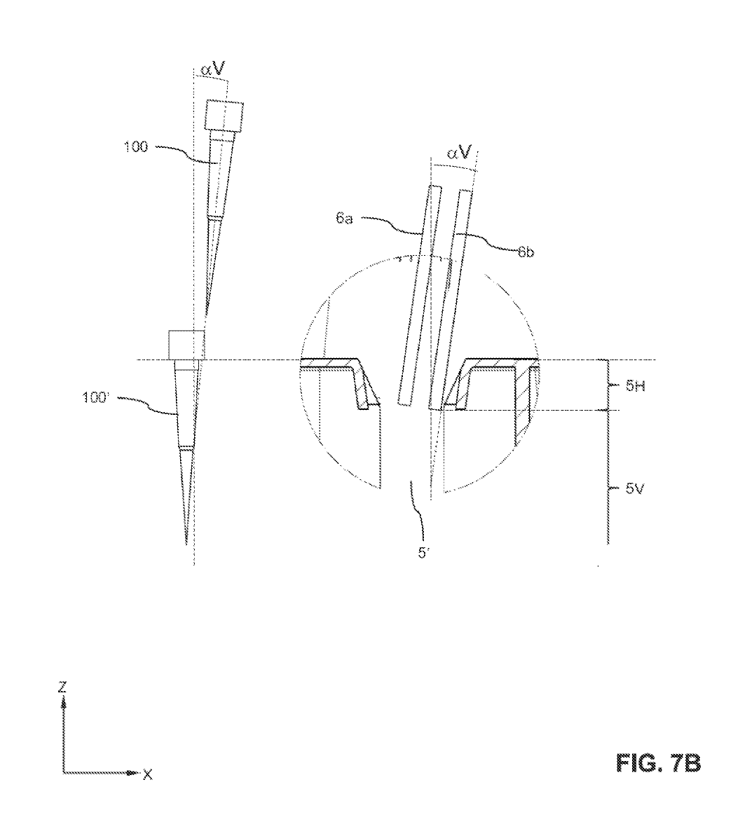

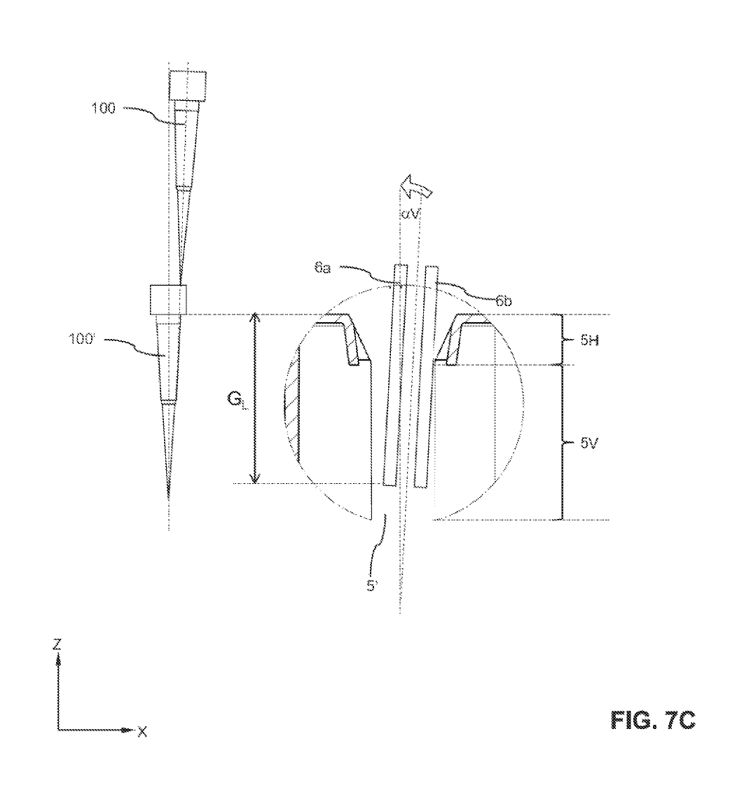

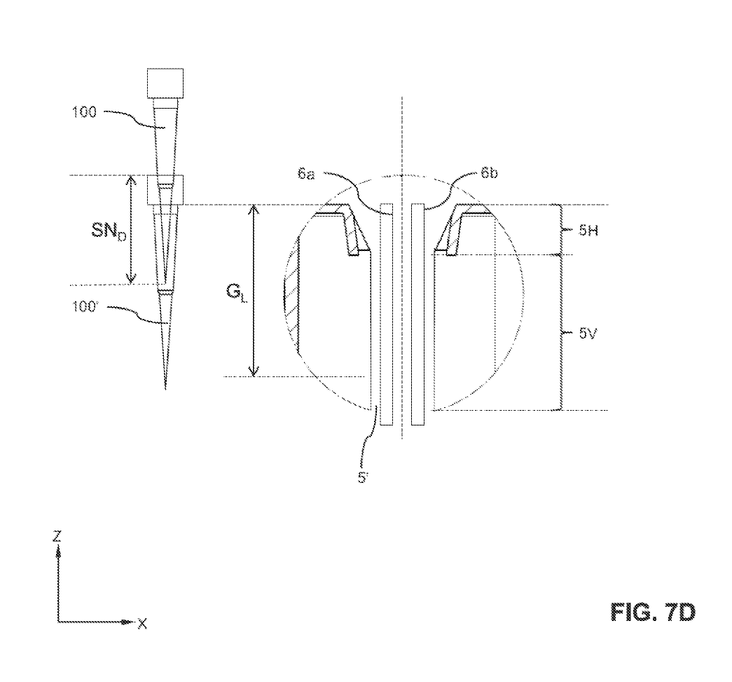

FIGS. 4A to 4C show various views of a rack 1 for holding assay tips 100. As exemplary shown on the figures, the surface plate 3 can be arranged on the top of the rack 1 (when viewed in the Z direction of the three-dimensional Cartesian coordinate system). Even though embodiments depicted on the figures show rack(s) 1 with (rounded) rectangular surface plates 3, the surface plate need not be necessarily rectangular, dependent on the particular requirements of the rack and/or analytical device. The surface plate 3 can comprise assay tip through boreholes 9 extending substantially in a Z direction orthogonal to the surface plate 3. The assay tip through boreholes 9 can have seating areas 9s for receiving the assay tips 100, see the magnified details of FIG. 4A but also FIG. 7B and related paragraph(s) of the description. In particular, the seating area 9s can be configured as a ring-shaped raise above the upper surface 3.1 of the surface plate 3. The ring-shaped raise can optionally be provided with a circumferential cut-out section for a gripper to grasp the underside of the next portion 101 of an assay tip 100.

FIG. 4B shows an arrangement of the surface plate 3. The assay tip through boreholes 9 can be arranged in a number of rows and columns across the surface plate 3. The rack 1 can further comprise a peripheral skirt 7 extending from a periphery of the surface plate 3 substantially in the Z direction. The peripheral skirt 7 can have therefore the shape of a hollow prism or truncated pyramid, having the surface plate 3 as base and open bottom. Accordingly the peripheral skirt 7 of embodiments having a surface plate 3 with a rounded rectangular shape can be a hollow and open prism with a rounded rectangular cross section.

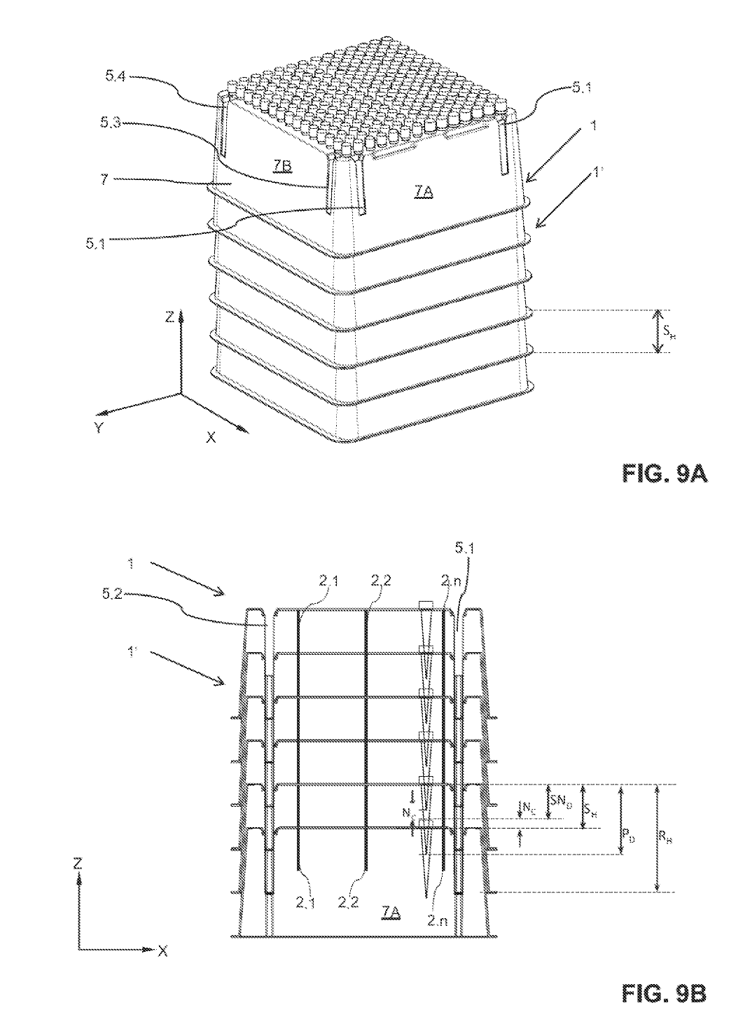

A feature of further embodiments of the rack 1, 1′ is shown on the cross section along plane Z-X of FIG. 4C, namely the stop(s) 2.1-2.n which can be configured to define the stacking height S_{H} of the racks 1, 1′ by way of being configured such that the stop(s) 2.1-2.n of a rack 1 can rest on the upper surface 3.1′ of the surface plate 3′ of a rack 1′ on which it can be stacked (see FIG. 9B). In some embodiments, the stops 2.1-2.n can be located on the inside and in an upper part of the peripheral skirt 7, comprising a longitudinal rib extending in the negative Z direction and can spread around the inner circumference of the peripheral skirt 7 in order to distribute the weight of the stack of racks (and if it is the case, a load applied thereon) on the surface plate 3. In any case, the stops 2.1-2.n can be arranged such as not to contact the assay tips 100 received in the rack 1′ below.

Alternatively (not shown on the figures), the slits 5, 5.1-5.m themselves may be configured to provide a stop for the corresponding rail 6, 6.1-6.m, defining a stacking height S_{H} of the stacked racks 1.

According to some embodiments, the peripheral skirt 7 can be tapered outwards such that a lower part of the peripheral skirt 7 of an upper rack 1 can accommodate an upper part of a lower rack 1′ on which the upper rack 1 is stacked. The peripheral skirt 7 of these embodiments therefore can have the shape of a hollow truncated pyramid with an open bottom and a rounded rectangular cross section.

The peripheral skirt 7 can comprise guiding elements extending substantially in the Z direction, each guiding element comprising a slit 5, 5.1-5.m and a corresponding rail 6, 6.1-6.m. As shown, the rails 6, 6.1-6.m can be arranged on the inside and in a lower part of the peripheral skirt 7 and the slits 5, 5.1-5.m can be arranged on the outside and in an upper part of the peripheral skirt 7.

The term “substantially” can be used herein to refer to extend the scope of properties of features to cover production tolerances/errors and/or minor deviations of the property that do not affect the functional characteristics of the feature to serve its purpose.

The term “inside” as used herein with reference to “the inside” of the peripheral skirt 7, can refer to the side of the sidewalls 7A-7D of the peripheral skirt 7 facing the hollow space defined by the peripheral skirt 7 and the surface plate 3.

The term “outside” as used herein with reference to “the outside” of the peripheral skirt 7, can refer to the side of the sidewalls 7A-7D of the peripheral skirt 7 facing away from the hollow rack 1.

The term “lower part” as used herein with reference to “the lower part” of the peripheral skirt 7, can refer to a lower portion of the peripheral skirt 7 in the negative Z direction (of the three-dimensional Cartesian coordinate system) substantially orthogonal to the surface plate 3, in particular, a lower part extending to the lower extreme edges of the side walls 7A-7D of the peripheral skirt 7.

The term “upper part” as used herein with reference to “the upper part” of the peripheral skirt 7, can refer to an upper portion of the peripheral skirt 7 in the positive Z direction (of the three-dimensional Cartesian coordinate system) substantially orthogonal to the surface plate 3, in particular, parts extending to the upper extreme edges of the side walls 7A-7D of the peripheral skirt 7 adjacent to the surface plate 3.

As shown on the figures, in particular on FIGS. 7A-7D, according to some embodiments, the rails 6 can each comprise a pair of ribs 6a respectively 6b arranged parallel to each other at a distance such as to allow the ribs 6a, 6b to slide into the corresponding slit 5, 5.1-5. A pair of ribs 6a, 6b can be advantageous over a single thick rib in that the thickness of a pair of ribs 6a, 6b can be freely defined, for example to be substantially identical to the thickness of the side walls 7A-7D of the peripheral skirt 7, which can be advantageous in manufacturing of the racks by molding, in particular, extrusion molding.

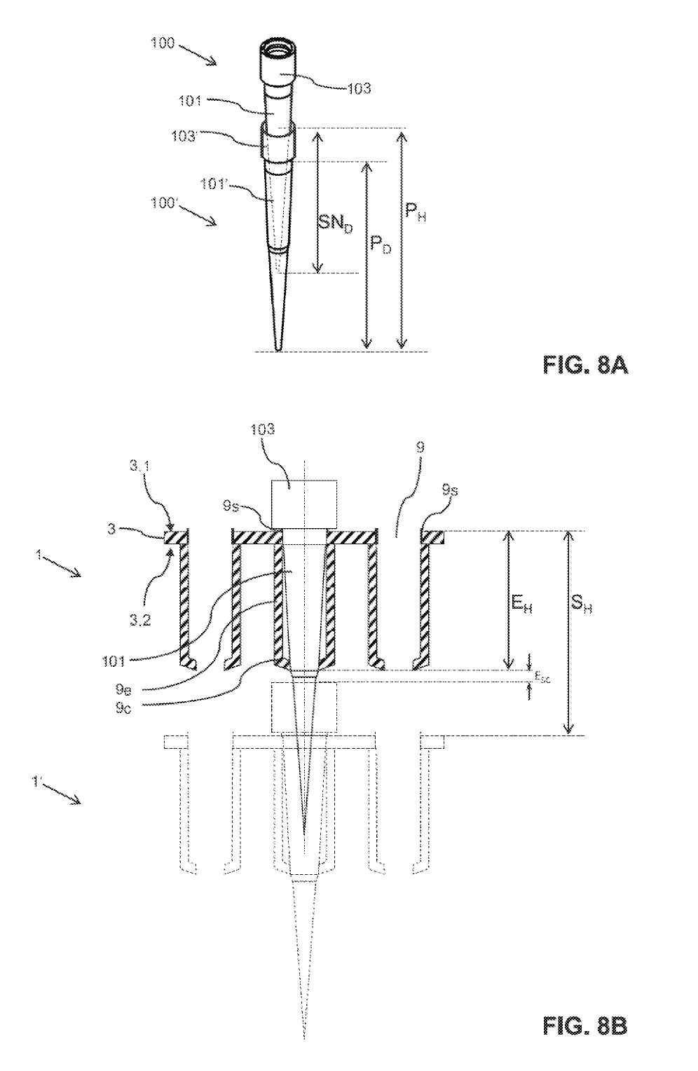

The guiding elements can be arranged such that the rack 1 can be aligned with a similar rack 1′ such that assay tips 100 received in the assay tip through boreholes 9 of the rack 1 can nest into the assay tips 100′ received in a similar rack 1′ when the racks 1, 1′ are stacked, as illustrated on FIGS. 8A-8B. The alignment can be achieved in that the rails 6, 6.1-6.m of the rack 1 can be guided into corresponding slits 5, 5.1-5.m′ of a similar rack 1′ when the racks 1, 1′ are stacked.

The term “aligned” can be used with reference to racks aligned upon stacking in the sense that the respective surface plates 3, 3 of the racks 1, 1′ can be all substantially parallel to the X-Y plane (vertical alignment) and the stacked racks can be brought into substantially identical positions and orientation in the X-Y plane (horizontal alignment) above each other (along the Z axis). In functional definition, the term “align” with reference to racks aligned upon stacking, can refer to the racks reaching an alignment sufficient so as to prevent assay tip collision. In other words, aligned cannot to be interpreted to mean a strict 100% geometrical alignment.

The term “substantially” can be used here in the sense to include a certain allowable error margin/tolerance, which can be low enough to allow assay tips 100 to nest without collision.

The term “vertical misalignment” (referenced to by vertical misalignment angle αV) as used herein can refer to racks 1, 1′ at an angle with respect to each other in the Z-X respectively Z-Y planes. Correspondingly, the term “vertical alignment” can be used to refer to reducing the vertical misalignment below the allowable error margin/tolerance to ensure the respective surface plates 3, 3 of the racks 1; 1′ can all be substantially parallel to the X-Y plane, thereby ensuring that the assay tips 100 nest without collision.

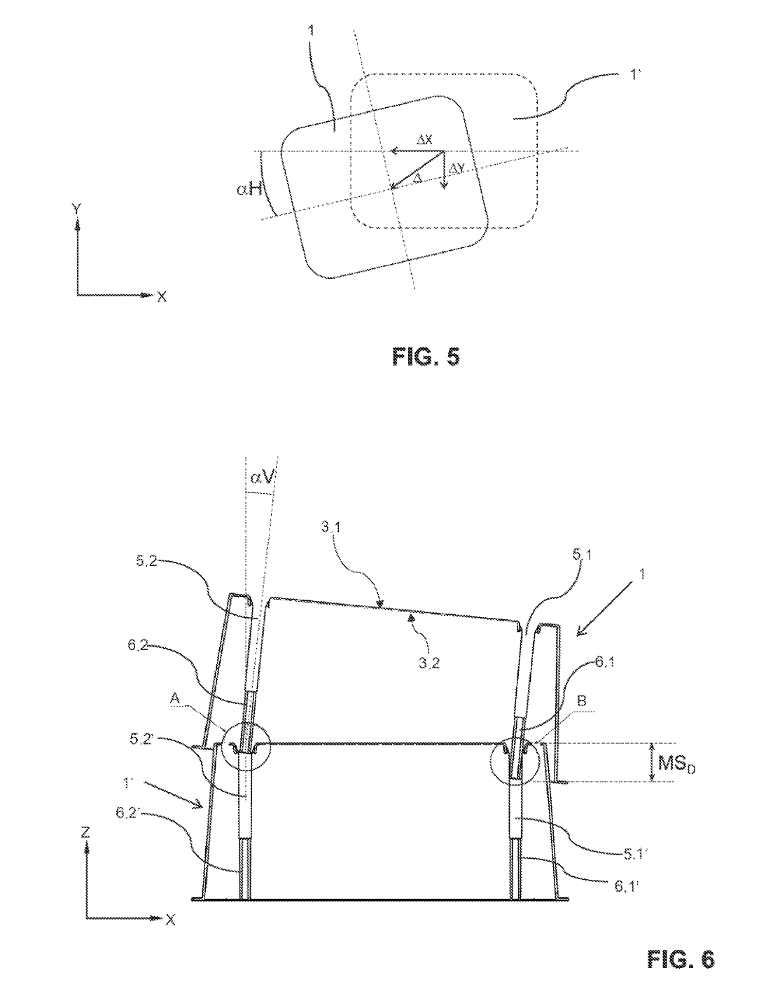

The term “horizontal misalignment” as used herein can refer to racks 1, 1′ being offset with respect to each other in the X-Y plane (referenced to by linear horizontal misalignment Δ, ΔX, ΔY) and/or horizontal angular misalignment (referenced to by horizontal misalignment angle αV) of the racks 1, 1′ in the X-Y plane (also referred to as orientation). Correspondingly the term “horizontal alignment” can be used to refer to reducing the linear horizontal misalignment Δ, ΔX, ΔY and/or the horizontal angular misalignment αH so that the stacked racks can be brought into substantially identical positions and orientation, thereby ensuring that the assay tips 100 nest without collision. The horizontal (mis)alignment of two racks 1, 1′ is exaggeratedly illustrated on FIG. 5.

As illustrated on the cross section along plane Z-X of FIG. 6, when a rack 1 is stacked over a similar rack 1′, rail(s) 5 of one rack 1 can slide into corresponding slit(s) 6′ of the other rack 1′ after a misaligned stacking depth M_{SD} is exceeded in order to align the racks 1, 1′.

The “term misaligned stacking depth” M_{SD} as used herein can refer to the deepest stacking depth reached by an upper rack 1 onto a lower rack 1′ upon stacking before the alignment. The misaligned stacking depth M_{SD} may also be defined as the distance in the Z direction (before the alignment) between the bottom of the peripheral skirt 7 of a rack 1 and the upper surface 3.1 of a further rack 1′ it is stacked on.

The sequence of FIGS. 7A-7D shows both vertical and horizontal alignment of racks upon stacking in a particular embodiment of the slits 5, 5′ of the guiding elements having a vertical alignment section 5V and a horizontal alignment section 5H, while the approach respectively nesting of the tips 100, 100′ being illustratively (in exaggerated proportions) shown on the side.

The horizontal misalignment angle αH can be reduced collaboratively by horizontal alignment sections 5H of multiple slits 5 arranged on substantially orthogonal side walls 7A-7D of the peripheral skirt 7 by way of a combination of linear horizontal alignments ΔX, ΔY in the X respectively Y directions.

The block arrow on FIG. 7A shows the linear horizontal alignment ΔX by way of the horizontal alignment section 5H of the slit 5 forcing the corresponding rib 6a sideways. As illustrated, the horizontal alignment section 5H can be configured as a funnel-like opening in the upper region of the slit 5 while the vertical alignment section 5V can be configured as an elongated trench-like cut in the lower region of the slit 5.

The detail FIG. 7B shows the vertical angular misalignment of the racks 1, 1′ by a vertical misalignment angle αV, as the rail 6 of an upper rack 1 enters the vertical alignment section 5V of the slit 5′ of a lower rack 1′ on which the higher rack 1 is stacked upon.

After the misaligned stacking depth MS_{D} is exceeded (not shown on FIGS. 7A-7D), the rail 6 of an upper rack 1 can slide into the vertical alignment section 5V of the slit 5′ of a lower rack 1′, the guiding element(s), i.e. the corresponding rails 6, 6′ and slits 5, 5′, forcing the racks 1, 1′ into alignment as shown on the detail FIG. 7C when a guiding length G_{L} is reached.

The term “guiding length” G_{L} can be used herein to refer to the depth the rails 6 of a rack 1 need to slide into the slits 5′ of a lower rack 1′ so that the racks 1, 1′ can be aligned sufficiently so as to avoid assay tip 100, 100′ collision. As seen on FIG. 7C, the guiding length G_{L} reached and the assay tip 100 received in the upper rack 1 can nest with the tip 100′ in the lower rack 1 without collision despite the fact that the racks 1, 1′ are not yet 100% aligned.

The end of the stacking process of the racks 10, 10′ is illustrated on FIG. 7D, the tips 100, 100′ having reached the safe nesting depth SN_{D}.

As illustrated, the slits 5, 5′ and the rails 6, 6′ may be dimensioned so as to allow for a predefined tolerance in order to ease stacking and to prevent racks 1, 1′ being stuck together.

It can be noted that while the horizontal respectively vertical alignments are separately described and illustrated, in reality, the alignment may be in fact one complex movement comprising linear and/or rotational component(s) along and/or around the X, Y, Z axes of the three-dimensional Cartesian coordinate system.

In order to prevent assay tip 100, 100′ collision on stacking, the rack height R_{H} may therefore be defined according to an embodiments as the sum of the pipette height P_{H} (see FIG. 8A) and the guiding length G_{L} of the guiding elements.

FIG. 8A shows two assay tips 100 and 100′ as they nest into each other after alignment of the racks. The term “nest” can be used herein in the sense that a part of a pointed portion 101 of an assay tip 100 can be located inside a further assay tip 100′ below.

FIG. 8A also shows the assay tip dive P_{D}, which can be equal to the height of an assay tip 100, 100′ as measured from the bottom of its pointed portion 101, 101′ up to a bottom part of its neck portion 103, 103′, the bottom parts of the neck portions 103, 103′ of the assay tips 100, 100′ configured to rest on the seating area of the through boreholes 9 of the surface plate 3 of the racks (see FIG. 8B). On the other hand, the assay tip height P_{H} can be defined as the height of the entire assay tip 100, 100′.

Also shown on FIG. 8A is the safe nesting depth SN_{D}, defined as the maximum distance the pointed portion 101 of the nesting assay tip 100, may intrude into the neck portion 103′ of the nestee assay tip 100′ without causing damage and/or the risk of getting stuck therein.

FIG. 8B shows a cross section of an embodiment of the assay tip through boreholes 9 comprising a tubular extension 9e extending beyond the lower surface 3.2 of the surface plate 3, the tubular extension 9e configured to define an exact radial position for the assay tips 100 received therein. The tubular extensions 9e can be advantageously slightly conical narrowing in the negative Z direction. In order to prevent assay tips 100 getting stuck therein and to provide a certain degree of production fault tolerance thereto, the tubular extensions 9e can be configured such as not to make contact with the assay tips 100 received therein along their entire inner length, but only around the seating area 9s and a circular contact surface 9c. The circular contact surface 9c may be provided as a radially extending lip of the tubular extension 9e, as illustrated in FIG. 8B.

In order to prevent damage to the assay tips 100, in particular their neck portions 103, the height of the tubular extensions E_{H} (measured from the top surface 3.1) can be chosen so that upon stacking of the racks 1, 1′, the tubular extension 9e of one rack 1 does not come in contact with the assay tip 100 received in the rack 1′ below, leaving an extension-bottom to tip neck stacking clearance E_{SC} therebetween. In other words, the height of the tubular extensions E_{H} can equal to the sum of the stacking height S_{H} and the extension-bottom to tip neck stacking clearance E_{SC}.

Referring back to FIG. 6, in order to ensure early alignment of the racks 1, 1 and to therefore avoid assay tip 100 collision, a pair of guiding elements 5.1-5.2; 5.3-5.4 respectively 5.5-5.6 can be arranged near opposing edges of the side wall(s) 7A-7D of the peripheral skirt 7. The term “opposing” with reference to opposing edges of a side wall can be used herein to refer to edges of the side wall(s) along the two opposing edges of the side wall(s) forming/part of/adjacent to different corners of the peripheral skirt 7. The term “near,” as used herein in the context of guiding elements arranged near an edge of a side wall, can refer to the general area as close as practically possible to the edges/corners of the side walls 7A-7D of the peripheral skirt 7. It can be apparent that the closer the guiding elements are located to the edges of the side walls 7A-7D, the earlier the racks 1, 1′ can be aligned upon stacking. Nevertheless, due to practical reasons, such as to ensure stability of the peripheral skirt 7 of the rack by having a sufficiently wide corner area, the guiding elements can be arranged according to one embodiments near the edges.

The stack of racks 1, 1′ after alignment is shown on FIG. 9A, with the stacking height S_{H} between subsequent racks 1 respectively 1′ of the stack indicated.

As apparent from the perspective view of FIG. 9A, in order to provide an alignment of angular misalignment in both Z-Y and Z-X planes of the three-dimensional Cartesian coordinate system, four guiding elements can be arranged near opposing edges of two substantially orthogonal side walls 7A-7C respectively 7B-7D of the peripheral skirt 7. Thus a first pair of the four guiding elements can be respectively arranged near opposing edges of a first side wall 7A and/or 7C of the peripheral skirt 7 and a second pair of the four guiding elements can be respectively arranged near opposing edges of a second side wall 7B and/or 7D of the peripheral skirt 7, substantially orthogonal to the first side wall 7A, 7C.

The term “substantially orthogonal” with reference to side walls 7A-7D of the peripheral wall 7, can be used to refer to side walls which, while not necessarily strictly orthogonal (in geometrical terms), due to outside taper of the peripheral skirt 7, can have substantially perpendicular intersections with section planes parallel to the X-Y plane. In other words, substantially orthogonal side walls can be side wall which can be orthogonal if the outside taper of the peripheral is not accounted for. For example, side walls 7A and 7B (see FIGS. 4A, 4B) can be considered as “substantially orthogonal” in the context of this disclosure.

FIG. 9B shows a cross section along plane Z-X of the stack of racks illustrating various parameters of the racks 1, 1′ in particular of the stack of racks:
The rack height R_{H} of a rack 1, 1′, referring to the overall effective height of an individual rack 1, 1′ from the surface plate 3 to the bottom of the peripheral skirt 7;
The stacking height S_{H}, defined as the effective distance between the same features of subsequent racks 1, 1′ of a stack, i.e. the distance from surface plate 3 of one rack 1 to the surface plate 3′ of the subsequent rack 1′;
The assay tip dive P_{D}, referring to the distance an assay tip intrudes into the rack (through the through boreholes) as measured from the surface plate 3 in the negative Z direction (which in the depicted embodiments is equal to the height of the pointed portion 103, 103′ of the assay tips 100, 100′ as measured from the bottom of their pointed portion 101, 101′ up to a bottom part of their neck portion 103, 103′);
The safe nesting depth SN_{D}, defined as the maximum distance the pointed portion 101 of the nesting assay tip 100 may intrude into the neck portion 103′ of the nestee assay tip 100′; and
The nesting clearance N_{C}, provided for in one embodiments of the rack as a safety clearance by which the stacking height S_{H} is increased as compared to the safe nesting depth SN_{D}. As seen illustrated on FIG. 8B, the effective stacking height S_{H} can therefore be the sum of the safe nesting depth SN_{D} and the nesting clearance N_{C}.

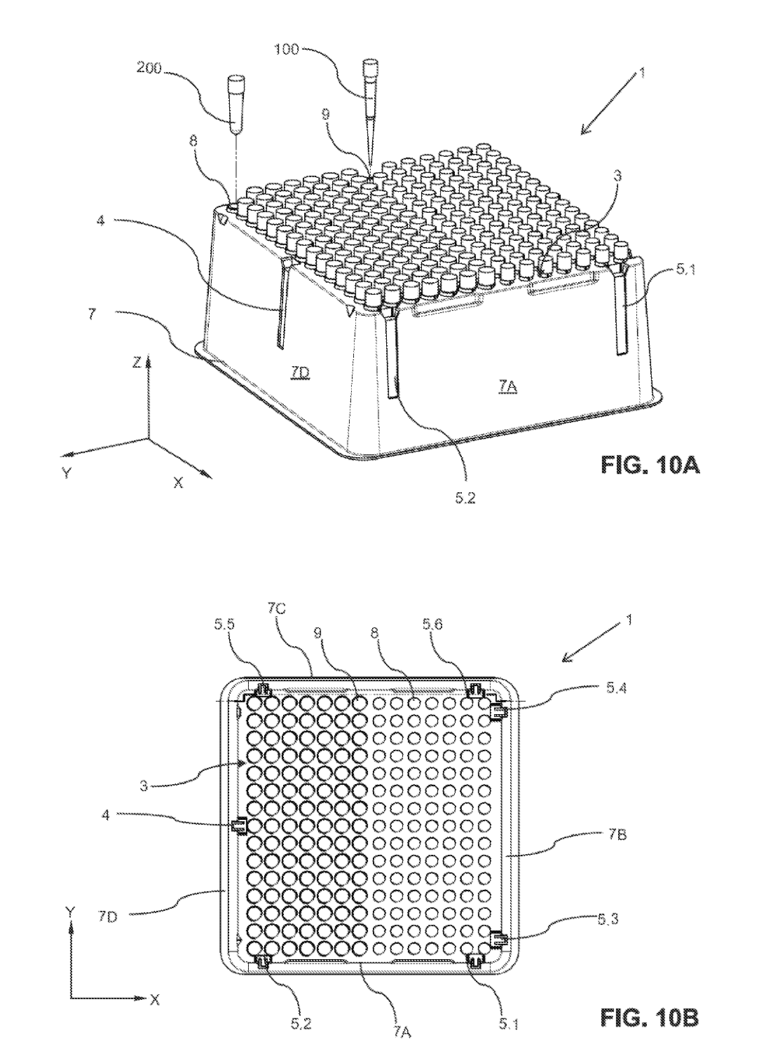

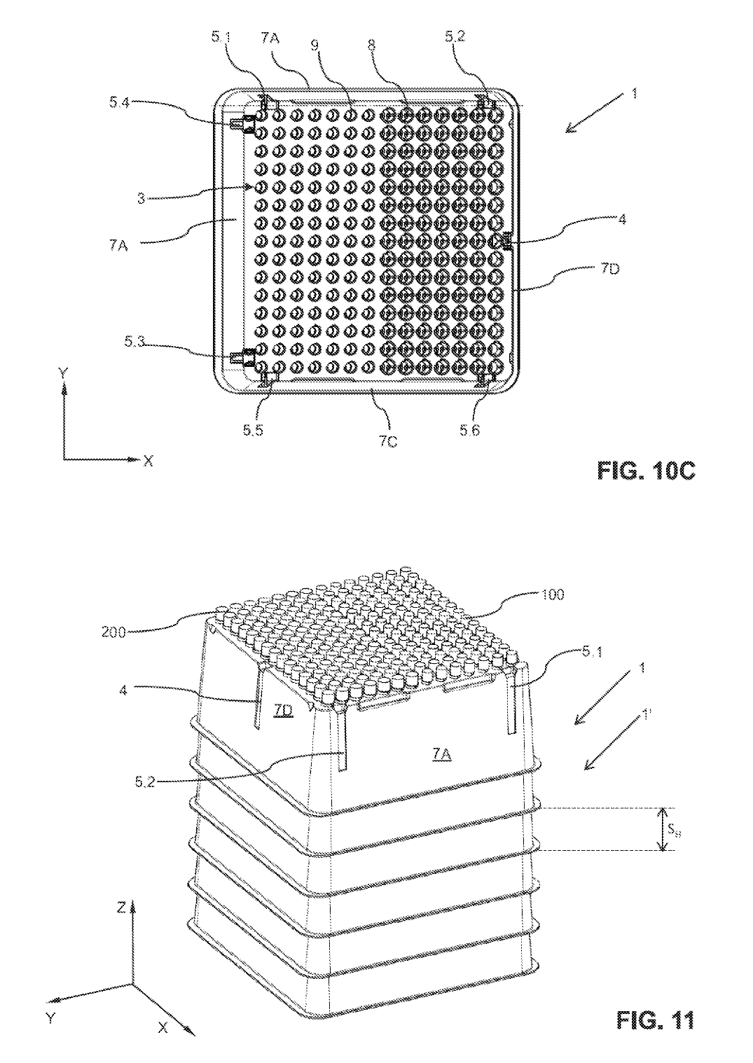

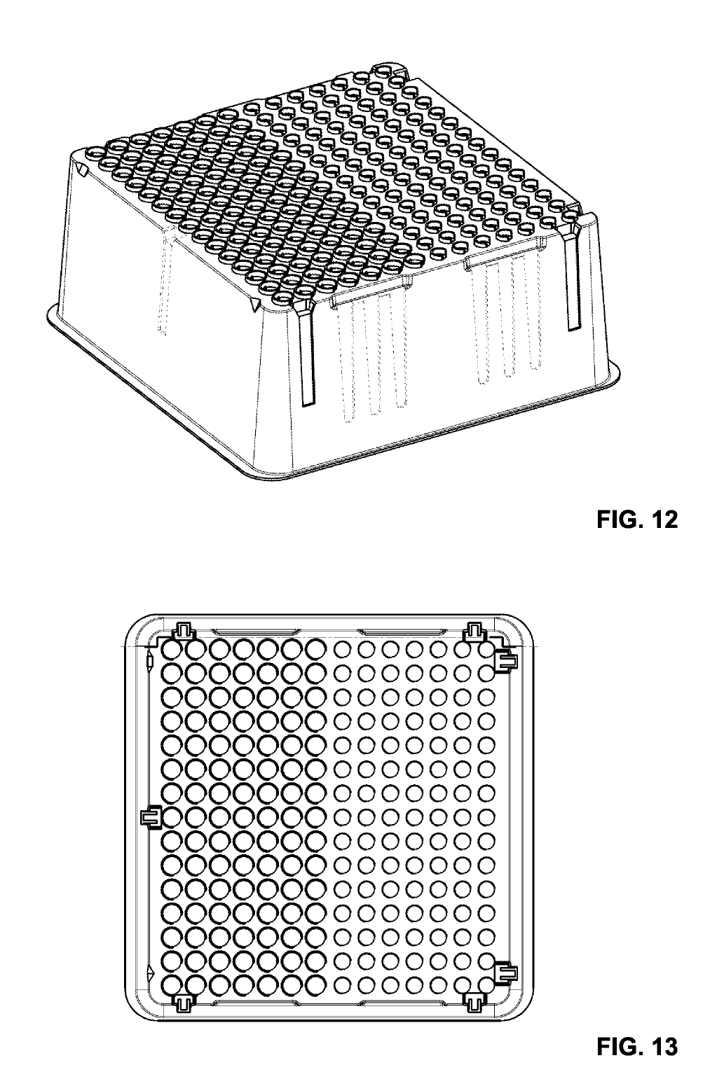

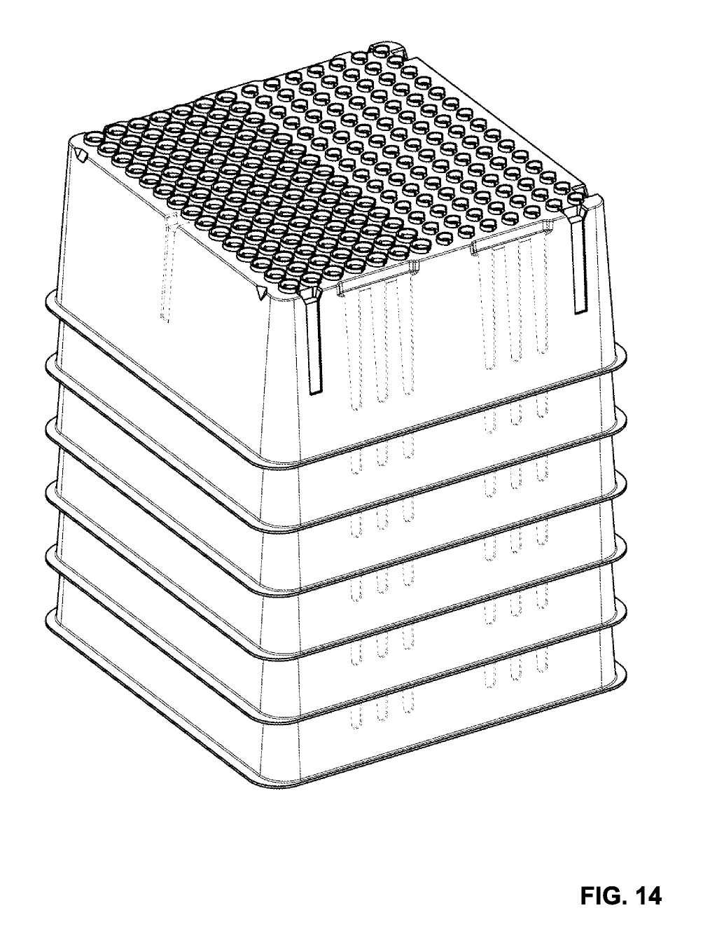

According to further embodiments of the rack 1 as shown on FIGS. 10A-10C, the surface plate 3 can further comprise a multitude of assay cup through boreholes 8 extending substantially in a Z direction orthogonal to the surface plate 3, the assay cup through boreholes 8 having seating areas for receiving assay cups 200 in the rack 1.

FIGS. 10A and 10B show a particular arrangement of the surface plate 3, wherein the assay tip through boreholes 9 and the assay cup through boreholes 8 can be arranged in a number of rows and columns across the surface plate 3. As analytical devices commonly require the same number of assay tips 100 and assay cups 200, it can be advantageous to provide the rack 1 with an identical number of assay tip through boreholes 9 and assay cup through boreholes 8 as shown on the figures. Due to the arrangement of the assay tip through boreholes 9 in rows/columns, one side of the surface plate 3 as well as one side wall 7D of the peripheral skirt 7 is not adjacent to any assay tip through boreholes 9 but only assay cup though boreholes 8. As assay cups 200 are commonly less prone to collision upon rack stacking (due to the lower height of the assay cups 200), only side walls 7A-7C adjacent to assay tip through boreholes 9 need be provided with guiding elements. This may leave a side wall 7D free of guiding elements, which, according to one embodiment, can be used to receive an orientation guide 4 configured to prevent a similar rack 1′ being stacked over the rack 1 in an incorrect orientation. The orientation guide 4 may take a form similar to the guiding elements (as illustrated) but may be in any other suitable form to prevent stacking in incorrect orientation (such as having a horizontal misalignment angle of 90°, 180° respectively 270°).

The term “orientation” as used herein with reference to the stacking orientation of racks, can be used to refer to the angular direction of a rack in the X-Y plane.

FIG. 10C shows a top-perspective view of the rack of FIG. 10A, the very small perspectiveness of the figure allowing revealing at least a part of the tubular extensions 9e of the assay tip through boreholes 9.

FIG. 11 shows a perspective view of a stack of racks 1, 1′ according to the embodiment of FIGS. 10A and 10B after alignment.

Embodiments of the disclosed rack may be made with any material, but in one embodiment, the racks are manufactured using, for example, of various plastic materials, such as polystyrene, by molding, such as by injection molding.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A rack for holding assay tips, the rack comprising:
a surface plate, the surface plate comprising assay tip through boreholes extending substantially in a Z direction orthogonal to the surface plate, the assay tip through boreholes having seating areas for receiving assay tips in the rack;
a peripheral skirt extending from a periphery of the surface plate substantially in the Z direction; and
at least four guiding elements extending substantially in the Z direction, a first pair of the four guiding elements being respectively arranged near opposing edges of a first side wall of the peripheral skirt and a second pair of the four guiding elements being respectively arranged near opposing edges of a second side wall of the peripheral skirt, substantially orthogonal to the first side wall,
wherein each guiding element comprises a slit and a corresponding rail, the guiding elements arranged such that the rail of the rack is guided into a corresponding slit of a similar rack thereby aligning the rack and a similar rack and such that assay tips received in the assay tip through boreholes of the rack nest into the assay tips received in assay tip through boreholes of the similar rack when the racks are stacked.

2. A rack according to claim 1, wherein each rail comprises a pair of ribs configured to slide in between the respective slit of the similar rack when the racks are stacked.

3. A rack according to claim 2, wherein the peripheral skirt is tapered outwards such that a lower part of the peripheral skirt of an upper rack accommodates an upper part of the similar rack when the racks are stacked.

4. A rack according to claim 3, wherein the rails are arranged on the inside and in a lower part of the peripheral skirt and the slits arranged on the outside and in an upper part of the peripheral skirt.

5. A rack according to claim 1, wherein each slit of the guiding elements comprises:
a vertical alignment section configured to provide an alignment of a vertical misalignment angle (αV) of the rack with respect to the similar rack in the Z-X and/or Z-Y planes of the three-dimensional Cartesian coordinate system; and/or
a horizontal alignment section configured to provide an alignment of a horizontal misalignment comprising a linear horizontal misalignment and/or a horizontal misalignment angle (αH) of the rack with respect to the similar rack in the X-Y plane of the three-dimensional Cartesian coordinate system.

6. A rack according to claim 5, wherein the vertical alignment section is configured as an elongated trench-like cut in the lower region of the slit.

7. A rack according to claim 5, wherein the horizontal alignment section is configured as a funnel-like opening in the upper region of the slit.

8. A rack according to claim 1, further comprising,
at least one stop configured such that the at least one stop of the rack rest on the surface plate of the similar rack when the racks are stacked, thereby defining a stacking height of the stacked racks.

9. A rack according to claim 1, wherein the slit provides a stop for the corresponding rail defining a stacking height of the stacked racks.

10. A rack according to claim 9, wherein the rack is configured such that the stacking height is equal to or greater than a maximum safe nesting depth of nested assay tips.

11. A rack according to claim 10, wherein the rack is configured such that the stacking height is greater than the maximum safe nesting depth of nested assay tips by a nesting clearance.

12. A rack according to claim 1, wherein the rack has a rack height equal to or greater than the sum of an assay tip height and a guiding length of the guiding elements, the guiding length being the length the rail(s) of the rack needed to slide in between the respective slit of the similar rack when the racks are stacked so that the racks are sufficiently aligned so as to avoid assay tip collision.

13. A rack according to claim 1, wherein the surface plate is substantially rectangular.

14. A rack according to claim 13, wherein the surface plate is of a rounded rectangle shape.

15. A rack according to claim 1, wherein the peripheral skirt has four side walls and a pair of guiding elements are arranged near opposing edges of each side wall(s) adjacent to assay tip through boreholes.

16. A rack according to claim 1, wherein the surface plate comprises assay cup through boreholes extending substantially in a Z direction orthogonal to the surface plate, the assay cup through boreholes having seating areas for receiving assay cups in the rack.

17. A rack according to claim 16, wherein an orientation guide is arranged on each side wall of the peripheral skirt non-adjacent to any assay tip through borehole, the orientation guide being configured to prevent a similar rack being stacked over the rack in an incorrect orientation.

18. A rack according to claim 16, comprising an identical number of assay tip through boreholes and assay cup through boreholes arranged in a number of rows and columns across the surface plate.

19. A rack according to claim 1, wherein each pair of guiding elements is arranged symmetrically on the side walls of the peripheral skirt.

20. A rack according to claim 1, wherein at least one pair of guiding elements is arranged asymmetrically on one side wall of the peripheral skirt such as to prevent a similar rack being stacked over the rack in an incorrect orientation.
